(19) United States
(12) Patent Application Publication
(10) Pub. No.: US 2009/0284023 A1
(43) Pub. Date: Nov. 19, 2009

(54) APPARATUS FOR PREVENTING OPENING OF A TRAY COVER FOR AN AUTOMOBILE

(75) Inventor: Tae Hyung Cho, Cheonan-si (KR)

Correspondence Address: KIRTON AND MCCONKIE, 60 EAST SOUTH TEMPLE,, SUITE 1800, SALT LAKE CITY, UT, 84111, US

(73) Assignee: NIFCO KOREA INC., Cheonan-si (KR)

(21) Appl. No.: 12/465,284

(22) Filed: May 13, 2009

(30) Foreign Application Priority Data
May 16, 2008 (KR) 2008-0045329
Sep. 10, 2008 (KR) 2008-0089307

(51) Int. Cl. E05C 1/08

(52) U.S. Cl. 292/34

(57) ABSTRACT

An apparatus for preventing opening of a tray cover for an automobile includes a main body of tray for receiving articles therein, and a cover rotatably mounted at a front part of the main body to open or close the main body. The cover is not opened even though the tray is applied with an external impact by the front or rear collision of vehicles, so that articles received in the main body of tray are prevented from rushing out of the receiving space to the outside. Therefore, it is possible to promote the safety of passengers and improve the safety and competitiveness of vehicles largely.

### BACKGROUND OF THE INVENTION

1. Field of the Invention

The present invention relates to an apparatus for preventing opening of a tray cover for an automobile, by which a cover rotatably mounted on a main body of a tray can be prevented from being opened by external impact.

2. Description of the Related Art

In general, a panel such as a dash board in a vehicle is mounted with a tray for receiving various articles therein.

The tray mounted in the vehicle usually includes a main body in the box shape with a space to receive particles inside, and a cover rotatably mounted at a front part of the main body of tray for opening or closing the tray.

Such a prior art tray for vehicles has, however, a disadvantage that the cover is opened unexpectedly by external impact applied by the front or rear side collision of vehicles so that articles received in the space of the main body of tray rush out of the tray, making passengers hurt.

In order to resolve the above disadvantage, a vehicle door pocket, which is not opened unnecessarily by the impact applied to a vehicle body, has been suggested in Japanese Patent Laying-Open Publication No. 2000-95028. More specifically, a holding element, which is rotatably supported by a receiving frame in the axial direction, is mounted with a hook element to be captured by a hook part of a door pocket and a weight, so that the hook element of the holding element is captured by the hook part of the door pocket by the action of the weight in response to the external impact applied to the vehicle body so as to prevent the door pocket from being opened out of the receiving position thereof.

### SUMMARY OF THE INVENTION

Therefore, the present invention has been accomplished in order to solve the above-mentioned and any other disadvantages, and an object of the present invention is to provide an apparatus for preventing opening of a tray cover for an automobile, which may prevent a tray cover from being opened by an external impact which is applied to a vehicle so as to promote the safety of passengers.

There is another object of the present invention to provide an apparatus for preventing opening of a tray cover for an automobile, in which the arrangement of a weight is improved for increasing the sensitivity of the weight as a G sensor for safety locking in response to an external impact, so as to surely prevent the tray cover from being opened by the external impact.

In order to achieve the above and any other objects of the present invention, in an apparatus for preventing opening of a tray cover for an automobile according to the present invention, a hinge connection bracket of a cover which is mounted to a main body of tray rotatably for opening or closing the main body is provided with a rotation guide hole and a rotation limiting hole, and a rotation limiting lever, which is rotatably mounted on the main body of tray and simultaneously supported by a lever spring, is mounted with a guide pin and a weight corresponding to the rotation guide hole and the rotation limiting hole.

In other words, an apparatus for preventing opening of a tray cover for an automobile includes a main body of tray in a box shape with a receiving space for receiving articles therein, and a cover rotatably mounted at a front part of the main body of tray for opening or closing the main body, and is characterized in that a hinge connection bracket formed at a side of the cover is formed with a rotation guide hole and a rotation limiting hole in a continuous manner, and a rotation limiting lever rotatably mounted at a side wall of the main body of tray and elastically supported by a lever spring is mounted with a guide pin corresponding to the rotation guide hole and the rotation limiting hole, and a weight for rotating the rotation limiting lever, so that the guide pin may advance into the rotation limiting hole from the rotation guide hole.

According to the present invention, the rotation guide hole formed in the hinge connection bracket of the cover is formed in an arc shape with respect to a hinge connection shaft, and the rotation limiting hole is formed in the arc shape with respect to a base part of the rotation limiting lever from a front end of the rotation guide hole to the hinge connection shaft. Further, the guide pin of the rotation limiting lever is protruded from an upper end of a connection lever which is formed in connection with a free end of the rotation limiting lever perpendicularly to the free end, and the weight is mounted at a lower end of the connection lever.

Further, one or more guide pin locking grooves are formed at an edge of the rotation limiting hole at the rotation guide hole side.

According to the present invention, the cover is not opened even though the tray is applied with an external impact by the front or rear collision of vehicles, so that articles received in the receiving space of the main body of tray are prevented from rushing out of the receiving space to the outside. Therefore, it is possible to promote the safety of passengers and improve the safety and competitiveness of the vehicles considerably.

Further, when the external impact is applied to the vehicle, the weight acts as a G sensor sensitively with respect to the impact, so that the opening of the tray cover is surely prevented.

### BRIEF DESCRIPTION OF THE DRAWINGS

The objects, features and advantages of the present invention will be more clearly understood from the preferred embodiments in the following detailed description in conjunction with the accompanying drawings, in which:

FIG. 1 is a perspective view illustrating a tray in an apparatus for preventing opening of a tray cover for an automobile according to a preferred embodiment of the present invention;

FIG. 2 is a side view illustrating a cover opening state of the vehicle's tray according to the preferred embodiment of the present invention;

FIG. 3a is a side view illustrating principal parts of the tray according to the preferred embodiment of the present invention, wherein the tray is not applied with shock; and

FIG. 3b is a side view illustrating the principal parts of the tray according to the preferred embodiment of the present invention, wherein the tray is applied with shock.

### DETAILED DESCRIPTION OF THE PREFERRED EMBODIMENT

Now, an apparatus for preventing opening of a tray cover for an automobile according to the present invention will be described in more detail with reference to a preferred embodiment in conjunction with accompanied drawings.

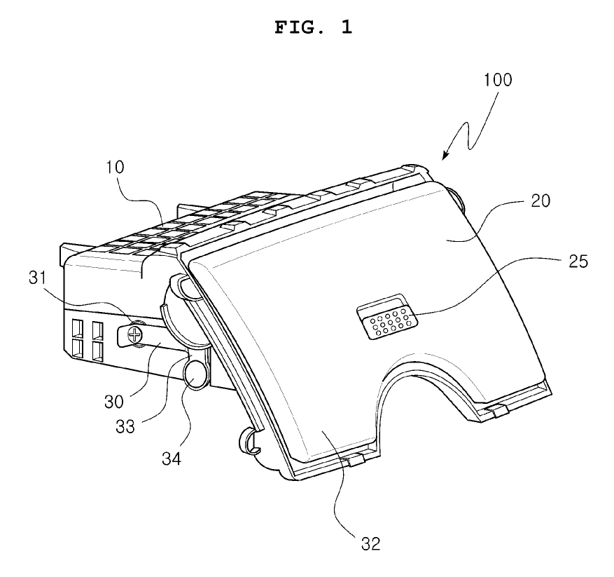

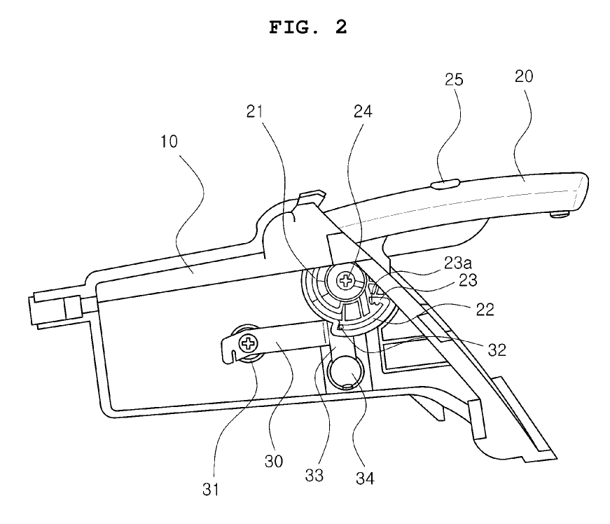

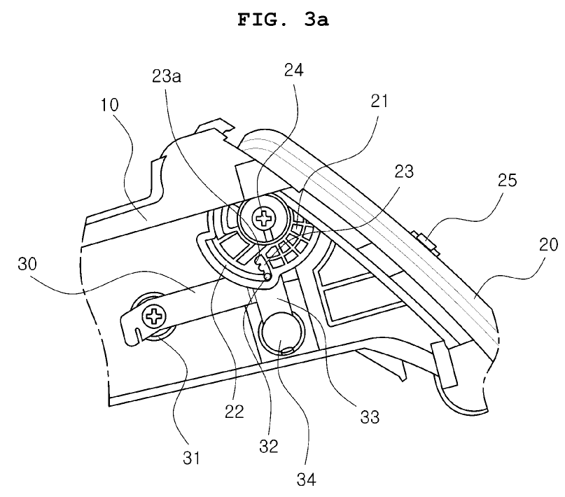

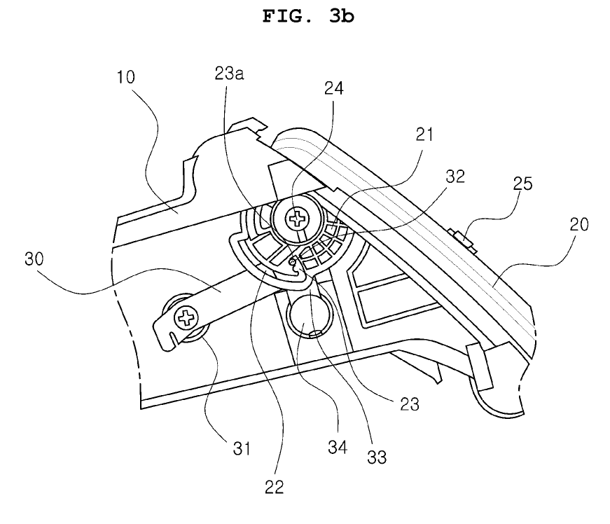

FIG. 1 is a perspective view illustrating a tray in an apparatus for preventing opening of a tray cover for an automobile according to a preferred embodiment of the present invention, FIG. 2 is a side view illustrating an opening state of the cover of the tray, and FIGS. 3a and 3b are side views respectively illustrating principal parts of the tray respectively before and after shock is applied to the tray.

In an apparatus for preventing opening of a tray cover for an automobile 100 according to the present invention, which includes a main body of tray 10 formed in the box shape with a receiving space for receiving articles therein, and a cover 20 rotatably mounted at a front part of the main body of tray 10 for opening or closing the main body 10, a hinge connection bracket 21 formed at a side of the cover 20 is formed with a rotation guide hole 22 and a rotation limiting hole 23 in the continuous manner, and a rotation limiting lever 30 rotatably mounted at a side wall of the main body of tray 10 and elastically supported by a lever spring 31 has a guide pin 32 to be slidingly fitted into the rotation guide hole 22 and the rotation limiting hole 23, and is mounted with a weight 34 for rotating the rotation limiting lever 30, so that the guide pin 32 may advance into the rotation limiting hole 23 from the rotation guide hole 22.

According to the present invention, the rotation guide hole 22 formed in the hinge connection bracket 21 of the cover 20 is formed in the arc shape with respect to a hinge connection shaft 24, and the rotation limiting hole 23 is formed in the arc shape with respect to a base part of the rotation limiting lever 30 from a front end of the rotation guide hole 22 to the hinge connection shaft 24. Further, one or more guide pin locking grooves 23a are formed at an edge of the rotation limiting hole 23 at the rotation guide hole 22 side. In addition, the guide pin 32 of the rotation limiting lever 30 is protruded from an upper end of a connection lever 33 which is formed in connection with a free end of the rotation limiting lever 30 perpendicularly to the free end, and the weight 34 is mounted at a lower end of the connection lever 33.

An opening and closing knob 25 is mounted on a front surface of the cover 20 so that a user may manipulate the opening and closing knob 25 to release the locked state of the cover 20 as necessary.

According to the tray in an apparatus for preventing opening of a tray cover for an automobile of the present invention as constructed above, in the state that the cover 20 is closed as shown in FIG. 1, the locked cover is released by the opening and closing knob 25 which is provided in the center of the front surface of the cover 20. In this state, if the cover 20 is rotated upward, the cover 20 may be opened, as shown in FIG. 2, so that the user may insert or draw an article with respect to the inside of the main body of tray 10.

In the normal opening or closing of the cover 20, since the guide pin 32 of the rotation limiting lever 30 is positioned at the front end of the rotation guide hole 22 as shown in FIG. 2 and FIG. 3a, the rotation guide hole 22 of the hinge connection bracket 21 which rotates with respect to the rotation connection shaft 24 may pass the guide pin 32 smoothly.

When a strong impact is applied to the tray 100 by the front or rear collision of vehicles, the rotation limiting lever 30 rotates in the counterclockwise direction to be lifted by the repulsive force of the weight 34 of the connection lever 33 and the elasticity of the lever spring 31 as shown in FIG. 3b, so that the guide pin 32 of the rotation limiting lever 30 advances into the rotation limiting hole 23 from the rotation guide hole 22 so as to restrain the rotation of the hinge connection bracket 21, thereby preventing the cover 20 from being opened. Further, the guide pin 32 which is advanced into the rotation limiting hole 23 is locked in the guide pin locking groove 23a, so that the guide pin 32 is prevented from being deviated from the rotation limiting hole 23 to the rotation guide hole 22 by secondary reaction. Therefore, articles received in the receiving space of the main body of tray 10 are prevented from rushing out of the receiving space to the outside.

Then, as the external impact applied to the tray 100 is released, the rotation limiting lever 30 returns to the initial position thereof by the tare of the weight 34 of the connection lever 33 against the elasticity of the lever spring 31. In other words, the guide pin 32 is released from the guide pin locking groove 23a and simultaneously returns to the rotation guide hole 22 from the rotation limiting hole 23, so that the cover 20 may be opened or closed normally.

It should further be apparent to those skilled in the art that various changes in form and detail of the invention as shown and described above may be made. It is intended that such changes be included within the spirit and scope of the claims appended hereto.

What is claimed is:

1. An apparatus for preventing opening of a tray cover for an automobile, including a main body of tray in a box shape with a receiving space for receiving articles therein, and a cover rotatably mounted at a front part of the main body for opening or closing the main body, characterized in that:
a hinge connection bracket formed at a side of the cover is provided with a rotation guide hole and a rotation limiting hole in a continuous manner; and
a rotation limiting lever, rotatably mounted at a side wall of the main body of tray and elastically supported by a lever spring, has a guide pin to be slidingly fitted into the rotation guide hole and the rotation limiting hole, and is mounted with a weight for rotating the rotation limiting lever, so that the guide pin may advance into the rotation limiting hole from the rotation guide hole.

2. An apparatus for preventing opening of a tray cover for an automobile as claimed in claim 1, wherein the rotation guide hole formed in the hinge connection bracket of the cover is formed in an arc shape with respect to a hinge connection shaft; the rotation limiting hole is formed in the arc shape with respect to a base part of the rotation limiting lever from a front end of the rotation guide hole to the hinge connection shaft;
the guide pin of the rotation limiting lever is protruded from an upper end of a connection lever which is formed in connection with a free end of the rotation limiting lever perpendicularly to the free end; and
the weight is mounted at a lower end of the connection lever.

3. An apparatus for preventing opening of a tray cover for an automobile as claimed in claim 1, wherein one or more guide pin locking grooves are formed at an edge of the rotation limiting hole at the rotation guide hole side.

4. An apparatus for preventing opening of a tray cover for an automobile as claimed in claim 2, wherein one or more guide pin locking grooves are formed at an edge of the rotation limiting hole at the rotation guide hole side.
